(19) United States
(12) Patent Application Publication
(10) Pub. No.: US 2018/0017504 A1
(43) Pub. Date: Jan. 18, 2018

(54) VESSEL INSPECTION DEVICE

(71) Applicant: Muehlbauer GmbH & Co. KG, RODING (DE)

(72) Inventors: RALF FREIBERGER, DUEREN (DE); GUENTER HOCHWIMMER, RETTENBACH (DE); ULF PORTH, HUECKESWAGEN (DE)

(21) Appl. No.: 15/548,343

(22) PCT Filed: Feb. 3, 2016
(86) PCT No.: PCT/EP2016/052241

§ 371 Date: Aug. 2, 2017

(30) Foreign Application Priority Data
Feb. 3, 2015 (DE) 10 2015 001 332.7

(51) Int. Cl. G01N 21/90

(52) U.S. Cl. CPC G01N 21/909; G01N 21/9054; G01N 2201/0636

(57) ABSTRACT

A vessel inspection device for examining a vessel for damage in a filling region or opening region having a bead or a bulge, which bead or bulge forms an undercut, has a camera, an objective associated with the camera, and a further optical element, which can be adjusted and fixed in place in terms of their distances from and their orientation relative to one another and relative to an image recording axis, and the optical element is a mirror in the form of a ring mirror that widens toward the camera, the longitudinal section of which, containing the image recording axis, has the form of an ellipsis portion that is inclined relative to the image recording axis and displaced radially outward, wherein the ellipsis portion has two semi-axes that deviate from one another, and the device can be moved into an inspection position relative to the vessel to be inspected for inspection of the filling region or opening region of the vessel, during every inspection procedure.

### TECHNICAL FIELD, TECHNOLOGICAL BACKGROUND

In the following, a vessel inspection device is described. With this inspection device, vessels can be examined for damage, particularly at their sensitive bottle neck or can neck.

Here, vessels are understood to be cans and bottles suitable for holding foods, beverages, chemicals, medications, and other products, which cans or bottles must be examined for damage locations during the production and filling process. In this way, it can be ensured that on the one hand, the filling process proceeds without disruption, and that on the other hand, the content of the vessels does not spoil or is not impaired with regard to its quality, and that the liquids are reliably prevented from running out.

For this purpose, manual random samples have generally been taken during production until now. Alternatively or in addition, systems known from operation& practice also use frontal cameras for recording and image-processing the frontally photographed sensitive bottle neck or can neck.

Cans or bottles are formed in many configurations by means of forming a bead on the can neck or bottle neck in the filling region or opening region. This bead serves to attach a closure, for example in the form of a cover plate, a crown cork or the like. For this purpose, the bead is not allowed to have any defective locations. If the filling region or opening region was damaged during the forming process, so that a crown cork or a closure film/foil can no longer be set on in securely sealing manner, the corresponding bottle or can is discarded.

Bead edges on can openings or bottle neck bulges form undercuts that can be examined only with difficulty if the bottle neck or can neck is photographed frontally. Regions that lie below the plane of the filling region or opening region—seen from the direction of the camera—are not depicted or only depicted insufficiently, and therefore cannot be inspected sufficiently.

### STATE OF THE ART

Imaging optics are known from DE 103 12 051 A1, with which mantle surfaces of objects having rotation symmetry are depicted on an imaging plane by means of a reflective element, the reflective surface of which can have a circular cross-section in a plane perpendicular to the optical axis. In this regard, the angle between a light beam proceeding from the object and the optical axis is reduced, in each instance, by means of angle-reducing elements disposed in front of and behind the reflective element.

A camera having an optical element coupled with an image processing unit is known from DE 197 26 967 C1, This arrangement serves for optical imaging of a mantle surface of an object. A light beam deflection device is disposed at a distance above the object in order to deflect the light beam path from the side surfaces of the object to the camera free of distortion.

An inspection apparatus for examining vessels disposed in fixed manner on a processing machine is known from DE 10 2010 032 410 A1, which apparatus has a camera having a first optical component and is coupled with an image processing unit, and disposed in fixed manner with reference to a vessel to be inspected. A second optical component in the form of a mirror having a concave curvature or a parabolic mirror having a passage opening, or an endoscope lens serves for examining the vessel neck. The endoscope lens is held in the holding tube parallel and centered relative to a central axis of the holding tube, and a first end of the endoscope lens faces toward the camera. A recording region of the camera is adjustable with reference to a face surface at the first end of the endoscope lens, by means of the first optical element. A vessel situated in the inspection position faces toward a second end of the endoscope lens with its vessel opening.

This arrangement probably does not fulfill the requirements with regard to great precision of the detection of defective locations, because in a further embodiment, two cameras and a lighting unit are provided in place of the one camera in this document. Only the use of the two cameras makes it possible, according to this document, to sufficiently evaluate the shadow regions of the vessel, since not all the beam paths reflected by the vessel can be focused by a single camera in the case of the mirror having a concave curvature or the parabolic mirror.

A method for scanning the surface of a cylindrical object, and a corresponding apparatus, are known from DE 40 24 546 C1. The surface of the object must be able to reflect, scatter or refract light. The apparatus has a light source, the light bundles of which are cast onto the object around a circumference band, reflected by the object, and afterward, the imaging light bundle is focused, by means of an imaging objective, onto an opto-electronic straight-line line sensor having an electrical evaluation device. Consecutive circumference regions of the object are scanned one after the other, in terms of time. An image rotation lens is disposed between the object and the line sensor, which lens brings about scanning of the object, on the one hand, and on the other hand compensates the rotation of the image generated by the imaging objective on the object circumference, in such a manner that the image always has the same orientation, independent of the angle of rotation, namely is guided parallel to the longitudinal axis of the object. In this way, the surface of objects having a relatively large diameter is supposed to be scanned without the use of a ring sensor or without being read out from a surface area sensor, with high circumferential resolution.

An apparatus for examining bottles for damage is known from DE 94 15 769 U1. The apparatus is supposed to serve the purpose of checking the mouth region and the thread on the bottle neck at the same time, using a single camera system. A corresponding mirror arrangement guides the view onto the mouth and the view onto the thread into the camera system jointly. In particular, the apparatus has a photo-sensitive image recorder and a lens that images the part of the bottle to be examined, which is situated in the direct beam path of the lens, in addition to the parts of the bottle situated in the direct beam path of the lens, on the image recorder.

EP1826556 (A2) discloses a testing device for workpieces having at least one electric camera having an objective, the optical axis of which can be oriented coaxially relative to an axis of symmetry or center axis of the workpiece, as well as a deflection mirror disposed in the beam path ahead of the objective, which mirror reflects the light emitted by the workpiece, which has rotation symmetry and can be placed almost coaxially in front of the objective, in a direction toward the camera, wherein the deflection mirror is configured as a hollow mirror or ring mirror having a center axis disposed coaxially relative to the optical axis of the objective, and has a reflection surface in the form of a conical mantle or partial sphere, and in addition to the image portion reflected directly by the deflection mirror to the objective, the light emitted by the workpiece and the related image portion can also be directly recorded by the camera, at least in part. For this purpose, the ring mirror or the reflection surface has a minimal diameter and a maximal diameter, wherein the minimal diameter is maximally as great as a workpiece width, and the workpiece can be placed coaxially relative to the ring mirror.

WO 90/04773 A1 relates to a method for examining a sequence of objects that have an end, in each instance, and sides next to the end. The method has the following steps: placing the object in an inspection station having an optical system directed in the direction of the end, wherein the optical system serves to generate a focused image, and each point on the object is considered in order to produce a corresponding point in the focused image. The optical system defines a sight line toward the end and light beams that are directed at a slant toward the sides, which are focused on a point in the image, in each instance. A two-dimensional image of the end and of the sides is recorded using the optical system. In this regard, the image is a focused but spatially distorted image of the end and of the sides, wherein the sides appear to be folded at the top, next to the end. Different objects are differentiated by means of recognition of characteristics that appear in the two-dimensional image.

Further technological background can be derived from the documents DE 197 26 967 C1, DE 103 12 051 A1, FR 2 896 040 A1, U.S. Pat. No. 5,912,776, EP 0 426 968 A1, WO 2009/066165 A1, DE 199 20 007 C1, and DE 91 02 935 U1.

### Fundamental Problem

Proceeding from this state of the art, the requirement exists of making available an improved inspection device and a corresponding method for examining vessels, which allows precise identification of damaged locations on the vessels to be inspected. This improved inspection is supposed to make deviations from a desired quality of vessels available precisely and reliably directly during the production process, so that corresponding steps (e.g. reworking or discarding the vessel in question) can be initiated.

### Solution of the Problem

The complete inspection device (=camera, objective lens, and optical element, and lighting device, if applicable) and the object to be inspected, having the undercut, in other words the vessel, for example, are not fixed in place relative to one another; instead, the inspection device and the object to be inspected are moved and positioned relative to one another for the inspection, in each instance. In this regard, camera, lens, and optical element are fixed in place relative to one another in terms of their distances, and the complete inspection device, having the optical element, the camera (with objective lens), and the lighting device are moved relative to the object to be inspected during each inspection procedure, in order to record the image. The optical element, which has rotation symmetry relative to the optical axis of the camera, depicts possible defects behind an undercut of the vessel on a magnified scale for the camera. In the inspection device described here, the optical element is a mirror, for example in the form of a ring mirror that widens toward the camera, the longitudinal section of which mirror, containing the image recording axis, has the form of an ellipsis portion inclined relative to the image recording axis and displaced radially outward.

### Advantages and Variants

The shape of the mirror, that of an inclined ellipsis portion displaced outward, has an improved light collection efficiency as compared with conventional parabolic mirrors, on the one hand, and on the other hand has a magnification effect and finally, also a focus that can be positioned more precisely onto the region of interest on the vessel, with an undercut at the edge or the opening of the vessel.

The device presented here can recognize defects from preceding production steps, in the case of bead-edged cans or bottles having a bulge in the filling region or opening region, to the side of and, in particular, behind the bead/bulge, in other words a region that is not seen in the usual frontal view. The solution presented here allows checking the region of interest on the vessel behind an undercut on the edge or checking the opening of the vessel for defects. At the same time, the face surface of the edge or of the opening of the vessel can also be inspected for defects.

This is accomplished using the solution presented here, although the shoulder and bead of a can or of the neck of a bottle can be shaped in many different ways. A parabolic mirror has a single focus. In contrast to this, an ellipsoid portion mirror, in which the generating ellipsis has two different semi-axes, as it does here, has two foci. Because of these two foci, both the magnification factor and the object detail of the region of interest that is recorded can be optimized by means of establishing the ellipsis parameters accordingly (semi-axes, angle of inclination of the ellipsis, and radial displacement). Furthermore, the object-side and the image-side numerical aperture can be optimized by establishing the length of the ellipsis portion.

The region of interest of the vessel and the inspection device must be positioned relative to one another, in the inspection position, in such a manner that the region of interest lies in the focal plane of the rotation ellipsoid portion. Using a mirror of the type described here, both the region of interest of the vessel behind the undercut (in other words, seen from the direction of the camera, behind the edge or the opening of the vessel) as well as the face surface of the edge or of the opening of the vessel can be focused at the same time, using the camera. A parabolic mirror, for example, does not allow this, because it projects only one location, namely the region behind the undercut, into infinity. If the camera, with its objective for recording the undercut, is now also set for infinity, the face surface of the edge or of the opening of the vessel, which does not lie at infinity, cannot be focused with this camera/objective setting.

Vessels to be examined using the solution described here can be produced from metal, plastic (e.g. PET or the like), ceramic or glass. The arrangement described here is suitable and intended for determining damage to the surface of such vessels by means of image recording and subsequent image processing. In this connection, damage of the type to be determined includes scratches, projections, burrs, dents, cracks or fissures, (micro)-holes, asymmetries or the like, on the inside or outside of the vessel.

The lighting device forms an optional part of the inspection device, which illuminates the region of interest behind the undercut either directly or indirectly.

A further variant of the present vessel inspection device is set up and suitable for inspecting different vessels (shape, length, diameter of the vessel opening region, etc.). In order to achieve optimal illumination and optimal recording of the region of interest, while simultaneously eliminating outside light influences, for vessels having different shapes, in one variant of the inspection device the optical element is disposed at one end of a tubular section that carries the camera with its objective lens at its other end.

In this regard, the optical element is configured so that it can be displaced longitudinally and/or inclined relative to the image recording axis for focusing on the camera lens, and so that it can be fixed in place in the desired focus position. In this regard, the optical element can simply be accommodated at the end of the tubular section in replaceable and locking manner, while maintaining the focusing position or adjustment position. This can be implemented, for example, by means of a spring-loaded journal that dips into a lateral opening of the tube, a screw connection or a bayonet connection, which locks the optical element on the tubular section in captive manner, directly or indirectly.

The lighting device can be affixed in concentrated manner at one end of the tubular section, distributed over the tubular section at both ends, or along the expanse of the tubular section.

A variant with indirect affixation of the optical element at the end of the tubular section can also be implemented by means of a ring of the lighting device provided between the optical element and the end of the tubular section. The lighting device emits light in a wavelength range correspondingly coordinated with image recording (visible light, infrared, ultraviolet)—indirectly—onto the optical element and/or directly onto the region of interest on the vessel.

In one variant of the inspection device described here, the vessels to be inspected are disposed in an inspection position in fixed manner on the processing machine, for example in what is called a teaser wheel or nippers turntable.

The camera with the objective lens is disposed on the processing machine along the optical axis of the camera and of the objective lens, so as to be movable with respect to an inspection position.

In one variant of the inspection device, the camera is connected with an image processing unit. The image processing unit can be equipped with a processor set up and programmed for image processing and image evaluation, which is thereby able to determine damage to the surface of the vessels. For this purpose, a database containing comparison images of defect-free regions of interest, for example, can be assigned to the processor. The camera defines an image recording axis with its objective lens, which axis aligns with the center longitudinal axis of the vessel when it is in the inspection position.

The tubular section with the optical element at the end of the tubular section and, if applicable, the lighting device, is disposed on the camera and its objective lens in such a manner that the optical element lies away from the camera at the end of the tubular section. The optical element interacts with the objective lens in order to allow the camera to record a focused image of the region of interest on the vessel, as soon as the optical element has assumed its intended inspection position relative to the region of interest on the vessel. For this purpose, the tubular section with the optical element, the camera, and the objective lens, as well as, if applicable, the lighting device, as a unit, and the region of interest on the vessel, on the other hand, are disposed so as to be displaceable relative to one another, in such a manner that the camera is enabled to focus on the region of interest.

The tubular section, the optical element at the end of the tubular section, and, if applicable, the lighting device enclose a cavity, at least in part, which cavity is dimensioned in such a manner that the region of interest on the vessel behind the undercut in the direction of the vessel opening can dip into this cavity by at least a certain distance, in order to assume its inspection position. For this purpose, the inspection device has means for moving at least the optical element back and forth relative to the region of interest of the vessel, for recording an image. Subsequently, a further vessel to be inspected can be conveyed to its inspection position. In this way, a focused image of the vessel to be inspected, or, to state it more precisely, of the region of interest on the vessel behind the undercut in the direction of the vessel opening, can be produced using the camera.

In one variant, the optical element, the lighting device, and the camera with the objective lens form an inspection device on the tubular section, which device represents a unit that can be moved as a whole along the image recording axis.

### BRIEF DESCRIPTION OF THE DRAWINGS

Further goals, characteristics, advantages, and use possibilities are evident from the following description of exemplary embodiments, which are not to be understood as being restrictive, making reference to the related drawings. In this regard, all the characteristics described and/or shown in the figures form the object being disclosed here, individually or in any desired combination, even independent of their grouping in the claims or their antecedents. The dimensions and proportions of the components shown in the figures are not necessarily to scale, in this regard; they can deviate from what is illustrated here, in the case of embodiments to be implemented.

The device and method details explained above are presented in context. However, it should be pointed out that in each instance, they are also independent of one another and can also be freely combined with one another.

FIG. 1 illustrates a variant of an inspection device in a lateral schematic sectional view, with a vessel situated in an inspection position, wherein the optical element has a cross-section of an ellipsis portion displaced radially outward and inclined.

FIGS. 2 and 3 illustrate geometrical conditions and particularities of the optical element.

FIG. 4 illustrates a path/time diagram of a possible movement of the inspection device into/out of the inspection position.

### DETAILED DESCRIPTION OF THE DRAWINGS

The vessel inspection device 10 presented here will be explained using the figures. In this regard, a number of variants is possible, which, although they are not presented in detail in connection with the figures, are disclosed in the remainder of the specification.

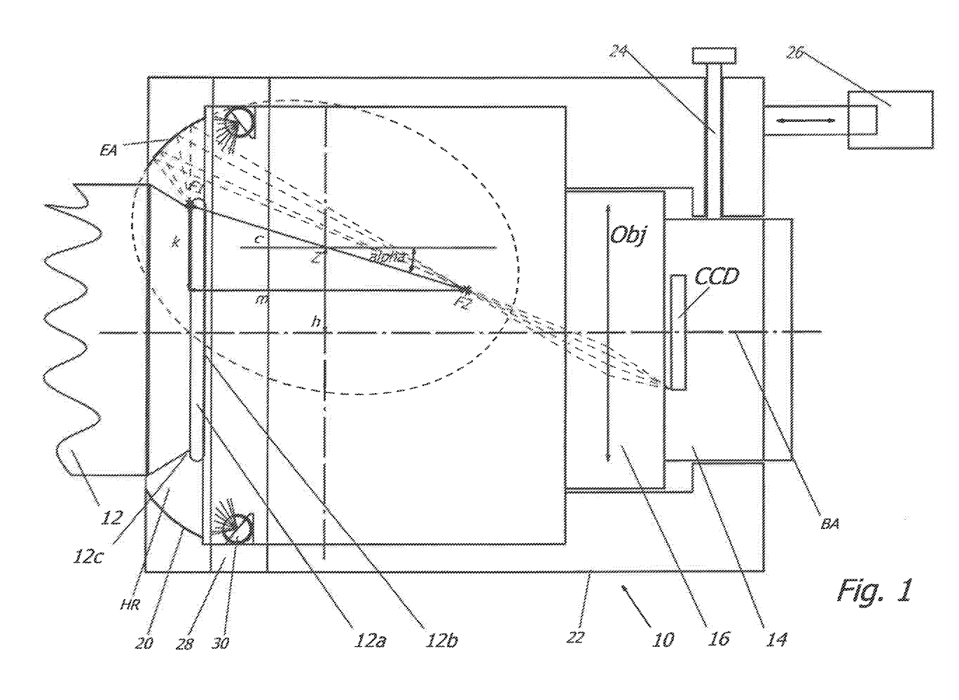

A vessel inspection device 10 illustrated schematically in FIG. 1 serves for examining a vessel, such as a (beverage) can 12 partially illustrated in FIG. 1, with regard to damage in a filling region or opening region 12b having a bead 12a or bulge, which bead or bulge forms an undercut 12c. The inspection device 10 has a camera 14 having an image recording element CCD, an objective lens 16 assigned to the camera 14, and a further optical element in the form of a mirror 20, which will be explained in detail below. These components 14-20 of the inspection device 10 can also be adjusted and fixed in place with regard to their distances from and orientation relative to one another and to an image recording axis BA, as will still be explained in detail below.

The optical element, in other words the mirror 20, a lighting device 30, and the camera 14 with the objective lens 16 form a unit that can be displaced as a whole along the image recording axis BA.

The mirror 20 is disposed at one end (on the left in FIG. 1) of a tubular section 22, which section carries the camera 14 with its objective lens 16 at its other end (on the right in FIG. 1), wherein the camera 14 and the optical element 20 are configured so that they can be displaced relative to one another and/or inclined relative to the image recording axis BA, and fixed in place in the desired focus position. The camera 14 is accommodated in the tubular section 22 so as to be displaceable along the image recording axis BA, and in the variant shown here, it can be fixed in place in the desired position and location by means of multiple adjustment and fixation screws 24 disposed distributed over the circumference of the tubular section 22.

An electrical, pneumatic or hydraulic linear drive 26 is articulated onto the tubular section 22 in order to move the inspection device 10 back and forth for recording an image, relative to the region of interest in the filling region or opening region 12b of the vessel 12.

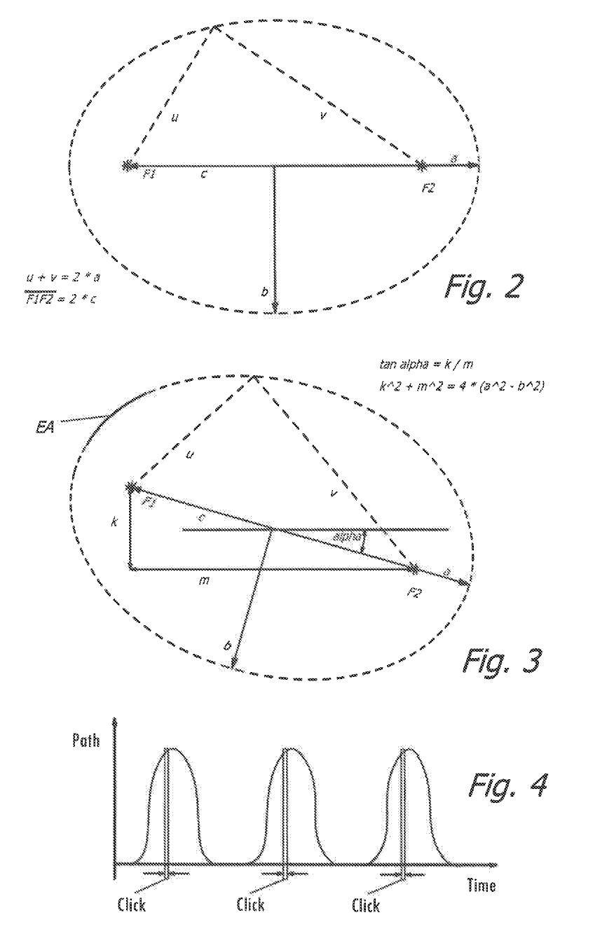

The geometrical conditions and particularities of the optical system, in other words of the mirror, will be explained by making reference to FIGS. 2 and 3. As illustrated in FIG. 1, the mirror 20 has the form of a ring mirror that widens toward the camera 14. This ring mirror has a mirror surface on its inside. This mirror surface has rotation symmetry. Its generatrix is a portion of an ellipsis that has two semi-axes a, b that deviate from one another. The ellipsis is inclined relative to the image recording axis BA, in its center Z, by an angle alpha, in such a manner that the portion EA of the ellipsis lies father away from the image recording axis BA (see FIG. 3). Furthermore, the center Z of the ellipsis, inclined by an angle alpha, is displaced radially outward from the image recording axis BA by a distance h. The portion EA of the ellipsis, positioned relative to the image recording axis BA in this manner, forms the generatrix of the mirror surface of the mirror 20, which surface can be thought of as having been formed by means of rotation of this generatrix about the image recording axis BA. The angle alpha by which the ellipsis, or, to state it more precisely, the portion EA of the ellipse is inclined, and the distance h, by which the ellipsis is displaced radially outward from the image recording axis BA, depend, among other things, on the dimensions of the vessel to be examined, the shape and the dimensions of the filling region or opening region 12b to be inspected, and the undercut 12c. The ring mirror 20 encloses a cavity HR, at least in part, which cavity is dimensioned in such a manner that a region of interest on the vessel 12, behind the undercut 12c in the direction of the filling region or opening region 12b, can dip into this cavity HR at least by a certain distance, so that the inspection device 10 and the region of interest on the vessel 12 assume the inspection position relative to one another.

The angle alpha, the distance h, as well as the semi-axes a, b are established in such a manner that the focus F1 of the ellipsis, which lies close to the portion EA of the ellipsis, lies behind the undercut to be inspected, and the second focus F2 of the ellipsis lies in the intermediate focus through which the light beams that come from the undercut pass when they are focused on the image recording element CCD by the objective. Details in this regard can be derived from FIG. 1-3.

In the variant illustrated in FIG. 1, a ring 28 having a lighting device 30 in the form of a plurality of light sources (e.g. LEDs) disposed on the inner circumference of the ring 28 is placed between the mirror 20 and the tubular section 22. This lighting device 30 serves to illuminate the region of interest behind the undercut 12c, either directly or indirectly (by way of the mirror surface). Depending on the structural conditions or the optical properties of the vessel 12 to be inspected (material, reflection properties or absorption properties), the lighting device 30 can also be affixed at both ends of the tubular section 22 or along the expanse of the tubular section 22, in variants not illustrated further here.

One or more LED light rings that emit their light onto a diffuse surface, in each instance, are situated in the lighting device, in order to produce as homogeneous a light as possible on the surface of the vessel. All the LEDs are operated in pulsed manner in one variant. In the variant illustrated in FIG. 1, the light sources emit light both directly onto the cover surface of the filling region or opening region and onto the torus-shaped side surface of the bead or the bulge, and onto the ring-shaped undercut (=rear side/underside of the bead).

The recorded image then shows three views, the top view from above onto the cover surface of the filling region or opening region, the torus-shaped side surface of the bead or of the bulge, and the ring-shaped undercut (=rear side/underside of the bead): The details of the undercut can only be recorded in that the edge of the ring mirror that faces the vessel 12 is situated correspondingly far behind the bead or the bulge of the filling region or opening region.

In variants other than the one shown here, it is provided that the light ring emits light that is reflected in the housing, and that a second light ring emits light directly in the direction of the vessel. The entire arrangement moves toward the can and is moved until the rear side of the bead can also be recorded.

Particularly in order to be able to inspect different vessels, the mirror 20 is disposed at one end of the tubular section 22, and the tubular section 22 carries the camera 14 with its objective lens 16 at its other end. Both the camera optics and the mirror are configured, in other variants, so as to be moved longitudinally relative to one another by means of bayonet closures, micro-threads, or the like. Furthermore, both the camera optics and the mirror can be structured so that they can be inclined relative to the image recording axis BA and fixed in place in the desired focus position. All the optical components (objective lens, camera optics, mirror, lighting device, if applicable) are always fixed relative to one another and are only changed in terms of their position and orientation relative to one another for adjustment purposes, for example.

Thus, the optical element 20 and/or the camera 14 with the objective lens 16 can be accommodated at the end of the tubular section in lockable and interchangeable manner, while maintaining the focus position or adjustment position.

In order to obtain the most precise and meaningful inspection result possible, the vessels 12 to be inspected are disposed or held on a respective processing machine in non-movable manner when the inspection device 10 is moved into the inspection position relative to the vessel 12 to be inspected, in each instance.

The camera and its objective lens define the image recording axis BA along the optical axis of the camera and of the objective lens, which axis aligns with the center longitudinal axis of the vessel 12 to be inspected when it is situated in the inspection position.

The inspection device 10 described above can be moved into/out of the inspection position at comparatively greater speed than conventional arrangements (for example known from DE 10 2010 032 410 A1), by means of the compact and reliable fixation of the positions and orientations of the components of the inspection device 10 relative to one another and to the vessel 12 to be inspected. While a fixed spatial relationship between the vessel in its inspection position and the camera is absolutely necessary in the case of this arrangement, the arrangement disclosed here provides for mounting the camera on the tubular section in fixed manner, and adjusting it in such a manner that it is always adjusted on the tubular section with regard to the ring mirror (and the lighting). Fixation and positioning of the vessels, which is not always precise in the prior art, can be at least partially compensated by the arrangement presented here.

The arrangement presented here, with a movable, in other words not permanently spatially fixed camera, is the better solution as compared with a locally fixed camera and a movable mirror, at least in some situations, because here, the adjustment of the camera with regard to the ring mirror is established, while in the case of the movable mirror and the fixed camera, this adjustment must be found again every time the inspection position is approached.

Furthermore, it is possible, using the arrangement disclosed here, to produce an image of the region of interest, using the camera, when the entire inspection device 10 is in motion, in other words when the ring mirror is moving toward the vessel in order to allow it to dip into the cavity (“click” in FIG. 4 is the exposure period, in each instance), or when the inspection device 10 is moving away from the vessel, or when the inspection device 10 is standing still relative to the vessel. Image recording always takes place during the time period during which the vessel is surrounded by the ring mirror. If the vessel is recognized as being defective, it is ejected from the production process at a later point in time (for example blown out).

The variants of the vessel inspection device described above, as well as their structural and operational aspects, merely serve for a better understanding of their structure, their method of operation, and their properties; they do not restrict the disclosure to the exemplary embodiments, for example. The figures are partly schematic, with essential properties and effects being shown dearly magnified, in part, in order to illustrate the functions, principles of action, technical embodiments and characteristics. In this regard, every method of functioning, every principle, every technical embodiment, and every characteristic in the text and in the other figures can be freely and optionally combined with other methods of functioning, principles, technical embodiments, and characteristics that are contained in or evident from this disclosure, so that all possible combinations of the vessel inspection device can be associated. In this regard, combinations of all the individual explanations in the text, in other words in every section of the specification, in the claims, and also combinations of different variants in the text, in the claims, and in the figures are also included. The claims also do not limit the disclosure and thereby the combination possibilities of all the characteristics indicated, with one another. All the characteristics disclosed are explicitly also disclosed here individually and in combination with all the other characteristics.

1. A vessel inspection device for examining a vessel for damage in a filling region or opening region that has a bead or a bulge, forming an undercut, said inspection device comprising:
a camera, an objective assigned to the camera, and an optical element, which can be adjusted and fixed in place in terms of their distances from and orientation relative to one another and to an image recording axis, wherein
the optical element is a mirror in the form of a ring mirror that widens toward the camera, the longitudinal axis of which, containing the image recording axis, has the form of an ellipsis portion that is inclined relative to the image recording axis and displaced radially outward, wherein the ellipsis portion has two semi-axes that deviate from one another, wherein the ellipsis portion is inclined by an angle relative to the image recording axis in its center, in such a manner that the ellipsis portion lies farther away from the image recording axis, and the center is displaced radially outward from the image recording axis by a distance, and wherein the inspection device can be moved into an inspection position for inspection of the filling region or the opening region of the vessel during every inspection procedure, relative to the vessel to be inspected.

2. The vessel inspection device according to claim 1, wherein a drive is provided to move at least the optical element back and forth relative to the region of interest of the vessel in order to record an image.

3. The vessel inspection device according to claim 1, wherein the optical element, a lighting device, and the camera with the objective lens form a unit that can be displaced as a whole along the image recording axis.

4. The vessel inspection device according to claim 3, wherein the lighting device is set up for illuminating the region of interest behind the undercut either directly or indirectly.

5. The vessel inspection device according to claim 3, wherein the lighting device is affixed at one end of a tubular section, at both ends of the tubular section or along the expanse of the tubular section.

6. The vessel inspection device according to claim 1, wherein the vessel inspection device is set up and suitable for inspecting different vessels, in that the optical element is disposed at one end of a tubular section, which carries the camera with its objective lens at its other end, wherein the camera optics and the optical element are structured so that they can be longitudinally displaced relative to one another and/or inclined relative to the image recording axis, and fixed in place in the desired focus position.

7. The vessel inspection device according to claim 5, wherein the optical element or the camera are accommodated at the end of the tubular section in replaceable and locking manner, while maintaining the focusing position or adjustment position, and
wherein the optical element is disposed at the end of the tubular section that lies away from the camera, and a ring provided between the optical element and the end of the tubular section, having at least part of the lighting device, is provided.

8. The vessel inspection device according to claim 1, wherein the vessel to be inspected is disposed or held on a respective processing machine in a non-movable manner, when the inspection device is moved into the inspection position relative to the vessel to be inspected.

9. The vessel inspection device according to claim 1, wherein the camera has an objective lens composed of one or more lenses, and the camera with the objective lens defines the image recording axis along the optical axis of the camera and the objective lens, which axis aligns with the center longitudinal axis of the vessel when it is in the inspection position.

10. The vessel inspection device according to claim 5, wherein the tubular section with the optical element at the end of the tubular section and of the lighting device on the camera and its objective lens are disposed in such a manner that the optical element lies away from the camera at the end of the tubular section, and wherein
at least the optical element encloses a cavity, at least in part, which cavity is dimensioned in such a manner that a region of interest on the vessel behind the undercut in the direction of the filling region or the opening region can dip into this cavity, at least by a certain distance, so that the inspection device and the region of interest on the vessel assume the inspection position relative to one another.

11. The vessel inspection device according to claim 8, wherein a teaser wheel or a nippers turntable is provided, in which the vessel to be inspected is firmly disposed on the processing machine in an inspection position.
